(19) United States
(12) Patent Application Publication
(10) Pub. No.: US 2023/0385547 A1
(43) Pub. Date: Nov. 30, 2023

(54) EVENT EXTRACTION METHOD AND APPARATUS, COMPUTER PROGRAM PRODUCT, STORAGE MEDIUM, AND DEVICE

(71) Applicant: Alipay (Hangzhou) Information Technology Co., Ltd., Hangzhou (CN)

(72) Inventors: Jun XU, Hangzhou (CN); Taifeng WANG, Hangzhou (CN); Mengshu SUN, Hangzhou (CN)

(21) Appl. No.: 18/322,444

(22) Filed: May 23, 2023

(30) Foreign Application Priority Data
May 24, 2022 (CN) 202210580427.8

(51) Int. Cl. G06F 40/284; G06F 40/166

(52) U.S. Cl. CPC G06F 40/284; G06F 40/166

(57) ABSTRACT

The present application discloses an event extraction method and apparatus, a computer program product, a storage medium, and a device. The method includes: identifying at least one trigger word in a target text, and obtaining a trigger word vector corresponding to each of the at least one trigger word; determining, in the target text, element word information associated with an event type corresponding to each trigger word based on the trigger word vector corresponding to each trigger word, an event type vector corresponding to each trigger word, and a relative location vector corresponding to each trigger word, where the element word information includes location information corresponding to each of at least one element word and an element relationship between the element words; and generating an event extraction result corresponding to the target text based on the location information of each element word and the element relationship between the element words, where the event type vector corresponding to each trigger word indicates the event type corresponding to the trigger word, and the relative location vector corresponding to each trigger word indicates a relative location relationship between a word and the trigger word in the target text.

### TECHNICAL FIELD

The present application relates to the field of computer technologies, and in particular, to an event extraction method and apparatus, a computer program product, a storage medium, and a device.

### BACKGROUND

With the rapid development of the Internet, an increasingly large amount of information is presented to users in the form of electronic text. To help the user quickly find required information from massive information, the concept of information extraction is proposed. Information extraction means to extract factual information from natural language texts and describe information in a structured form. Event extraction is an important research direction in information extraction, and mainly means to extract event information of interest from text data including event information, and present, in a structured form, events to be expressed in a natural language, for example, a specific person, a specific location, a specific time, and specific things that are done.

It can be seen that event extraction has a very broad application prospect in the current era of massive information.

### SUMMARY

Implementations of the present application provide an event extraction method and apparatus, a computer program product, a storage medium, and a device, to implement event extraction on a target text. The technical solutions are as follows:

According to an aspect, some implementations of the present application provides an event extraction method. The method includes: identifying at least one trigger word in a target text, and obtaining a trigger word vector corresponding to each of the at least one trigger word; determining, in the target text, element word information associated with an event type corresponding to each trigger word based on the trigger word vector corresponding to each trigger word, an event type vector corresponding to each trigger word, and a relative location vector corresponding to each trigger word, where the element word information includes location information corresponding to each of at least one element word and an element relationship between the element words; and generating an event extraction result corresponding to the target text based on the location information of each element word and the element relationship between the element words, where the event type vector corresponding to each trigger word is used to indicate the event type corresponding to the trigger word, and the relative location vector corresponding to each trigger word is used to indicate a relative location relationship between a word and the trigger word in the target text.

According to an aspect, some implementations of the present application provides an event extraction apparatus. The apparatus includes: a trigger word identification module, configured to: identify at least one trigger word in a target text, and obtain a trigger word vector corresponding to each of the at least one trigger word; an element word information acquisition module, configured to determine, in the target text, element word information associated with an event type corresponding to each trigger word based on the trigger word vector corresponding to each trigger word, an event type vector corresponding to each trigger word, and a relative location vector corresponding to each trigger word, where the element word information includes location information corresponding to each of at least one element word and an element relationship between the element words; and an event extraction module, configured to generate an event extraction result corresponding to the target text based on the location information of each element word and the element relationship between the element words, where the event type vector corresponding to each trigger word is used to indicate the event type corresponding to the trigger word, and the relative location vector corresponding to each trigger word is used to indicate a relative location relationship between a word and the trigger word in the target text.

According to an aspect, some implementations of the present application provides a computer program product. The computer program product stores at least one instruction, and the at least one instruction is adapted to be loaded by a processor and to perform the steps of the method described above.

According to an aspect, some implementations of the present application provides a storage medium. The storage medium stores a computer program, and the computer program is adapted to be loaded by a processor and to perform the steps of the method described above.

According to an aspect, some implementations of the present application provides an electronic device. The electronic device can include a processor and a memory. The memory stores a computer program, and the computer program is adapted to be loaded by the processor and to perform the steps of the method described above.

The technical solutions provided in some implementations of the present application bring at least the following beneficial effects:

In the implementations of the present application, the at least one trigger word in the target text is identified, and the trigger word vector corresponding to each of the at least one trigger word is obtained; then the element word information associated with the event type corresponding to each trigger word is determined in the target text based on the trigger word vector corresponding to each trigger word, the event type vector corresponding to each trigger word, and the relative location vector corresponding to each trigger word, where the element word information includes the location information corresponding to each of the at least one element word and the element relationship between the element words; and finally the event extraction result corresponding to the target text is generated based on the location information corresponding to each element word and the element relationship between the element words. In this way, event extraction on the target text is implemented. In the method in which the trigger word is first determined and the corresponding element word information is determined based on the trigger word, a problem, in the existing technologies, that it is difficult to extract an overlapping event and an event extraction result is unsatisfactory is effectively resolved, and an event extraction effect for the overlapping event is improved.

### BRIEF DESCRIPTION OF DRAWINGS

To describe the technical solutions in implementations of the present application or in the existing technologies more clearly, the following is a brief introduction of the accompanying drawings required for describing the implementations or the existing technologies. Clearly, the accompanying drawings described below are merely some implementations of the present application, and a person of ordinary skill in the art can derive other drawings from such accompanying drawings without making innovative efforts.

FIG. 1 is a model architecture diagram illustrating an event extraction model according to some implementations of the present application;

FIG. 2 is a schematic flowchart illustrating an event extraction method according to some implementations of the present application;

FIG. 3 is a schematic flowchart illustrating an event extraction method according to some implementations of the present application;

FIG. 4 is a schematic diagram illustrating an example of a second element matrix according to some implementations of the present application;

FIG. 5 is a schematic diagram illustrating an example of a directed acyclic graph according to some implementations of the present application;

FIG. 6 is a schematic diagram illustrating a structure of an event extraction apparatus according to some implementations of the present application;

FIG. 7 is a schematic diagram illustrating a structure of a trigger word identification module according to some implementations of the present application;

FIG. 8 is a schematic diagram illustrating a structure of an element word information acquisition module according to some implementations of the present application; and

FIG. 9 is a block diagram illustrating a structure of an electronic device according to an example implementation of the present application.

### DESCRIPTION OF IMPLEMENTATIONS

The technical solutions in the implementations of the present application are clearly and completely described below with reference to the accompanying drawings in the implementations of the present application. Clearly, the described implementations are merely some but not all of the implementations of the present application. Based on the implementations of the present application, all other implementations obtained by a person of ordinary skill in the art without making innovative efforts fall within the protection scope of the present application.

In the descriptions of the present application, it should be appreciated that the terms such as “first” and “second” are merely used for description, and cannot be understood as an indication or implication of relative importance. In the descriptions of the present application, it should be noted that the terms “including”, “having”, and any other variants thereof are intended to cover non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device. A person of ordinary skill in the art can understand specific meanings of these terms in the present application based on specific situations. In addition, in the descriptions of the present application, unless otherwise specified, “a plurality of” means two or more. “And/Or” describes an association relationship between associated objects, and indicates that three relationships may exist. For example, A and/or B may indicate the following three cases: Only A exists, both A and B exist, and only B exists. The character “/” usually indicates an “or” relationship between associated objects.

In an existing event extraction technology, a relatively good event extraction effect usually cannot be presented for a text including a plurality of overlapping events. In such text, it is usually difficult to extract an event due to overlapping of event trigger words or overlapping of event elements, and an event extraction result is usually unsatisfactory.

The following three example cases are used to illustrate, for descriptive purposes only, an overlapping event in a target text:

In a first case, there are events having a shared trigger word but different event types in the target text. For example, the target text is “ [symbol] [symbol] 600 [symbol] ” in Chinese (and in English “Zhang San Capital significantly increases shareholding of Reese by 600 million shares”). There are two event types of events: (1) stock investment, where “ [symbol] ” in Chinese (and in English “Zhang San Capital”) is a subject element word, “ [symbol] ” in Chinese (and in English “Reese”) is an object element word, and a trigger word is “ [symbol] ” in Chinese (and in English “increase”), and (2) stock purchase, where “ [symbol] ” in Chinese (and in English “Zhang San Capital”) is a subject element word, “ [symbol] ” in Chinese (and in English “Reese”) is an object element word, a trigger word is “ [symbol] ” in Chinese (and in English “increase”), and “600 [symbol] ” in Chinese (and in English “600 million shares”) is a quantity element word. It can be seen that event 1 and event 2 are two events of different event types, and a shared trigger word of the two events is “ [symbol] ” in Chinese (and in English “increase”).

In a second case, the same element word plays a different role in a different event types. For example, the target text is “ [symbol] [symbol] [symbol] , [symbol] ” in Chinese (and in English “Oriental Holdings acquires Welfare Ci at a low price to cash out 700 million, and then transfers Welfare Ci to Tianhai Energy”). There are two event types of events: (1) stock acquisition, where “ [symbol] ” in Chinese (and in English “Oriental Holdings”) is a subject element word, “ [symbol] ” in Chinese (and in English “Welfare Ci”) is an object element word, and a trigger word is “ [symbol] ” in Chinese (and in English “acquire”), and (2) stock transfer, where “ [symbol] ” in Chinese (and in English “Oriental Holdings”) is a subject element word, “ [symbol] ” in Chinese (and in English “Tianhai Energy”) is an object element word, a trigger word is “ [symbol] ” in Chinese (and in English “transfer”), and “ [symbol] ” in Chinese (and in English “700 million”) is a quantity element word. It can be seen that event 1 and event 2 are two events of different event types, but there is a common element word “ [symbol] ” in Chinese (and in English “Oriental Holdings”) in the two events.

In a third case, a plurality of events of the same event type share a trigger word. For example, the target text is “ [symbol] [symbol] [symbol] [symbol] [symbol] ” in Chinese (and in English “Oriental Holdings makes great efforts to acquire local leading enterprises Tiandi Source and East China Tiandi”). There are two events of the same event type: (1) stock acquisition, where “ [symbol] ” in Chinese (and in English “Oriental Holdings”) is a subject element word, “ [symbol] ” in Chinese (and in English “Tiandi Source”) is an object element word, and a trigger word is “ [symbol] ” in Chinese (and in English “acquire”), and (2) stock transfer, where “ [symbol] ” in Chinese (and in English “Oriental Holdings”) is a subject element word, “ [symbol] ” in Chinese (and in English “East China Tiandi”) is an object element word, and a trigger word is “ [symbol] ” in Chinese (and in English “acquire”). It can be seen that event 1 and event 2 are two events of the same event type, but there is a shared trigger word “ [symbol] ” in Chinese (and in English “acquire”) in the two events.

Implementations of the present application provide an event extraction method in which at least one trigger word in a target text is first identified, and a trigger word vector corresponding to each of the at least one trigger word is obtained; then element word information associated with an event type corresponding to each trigger word is determined in the target text based on the trigger word vector corresponding to each trigger word, an event type vector corresponding to each trigger word, and a relative location vector corresponding to each trigger word, where the element word information includes location information corresponding to each of at least one element word and an element relationship between the element words; and finally an event extraction result corresponding to the target text is generated based on the location information corresponding to each element word and the element relationship between the element words. In this way, event extraction on the target text is implemented. In the method in which the trigger word is first determined and the corresponding element word information is determined based on the trigger word, a problem, in the existing technologies, that an event extraction result of extracting an overlapping event is unsatisfactory is effectively resolved, and an event extraction effect for the overlapping event is improved.

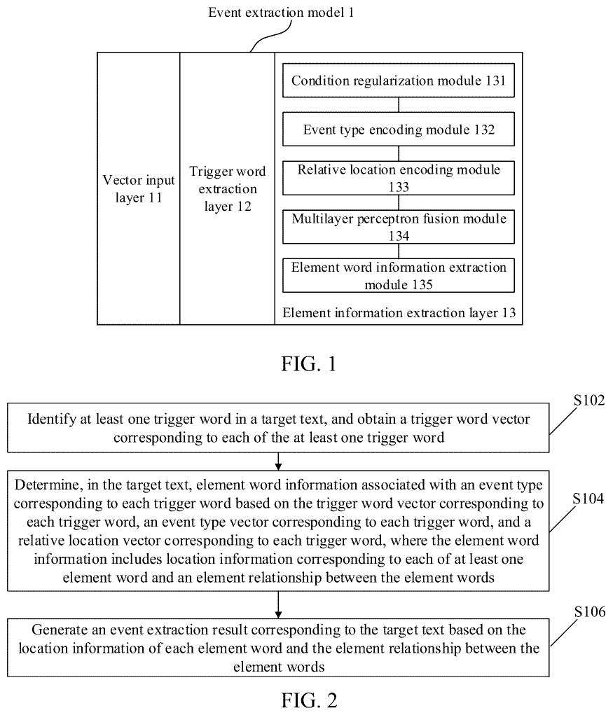

FIG. 1 is a model architecture diagram illustrating an event extraction model according to some implementations of the present application. As shown in FIG. 1, the event extraction model 1 is a deep learning-based neural network model. The event extraction model 1 includes a vector input layer 11, a trigger word extraction layer 12, and an element information extraction layer 13.

The vector input layer 11 is configured to: vector an input target text to generate an original word vector corresponding to each word in the target text, and use the original word vector as a model input.

The trigger word extraction layer 12 includes a plurality of binary classifiers, and is configured to: identify and extract a trigger word in the target text from the original word vector, and generate a trigger word vector.

The element information extraction layer 13 includes a condition regularization module 131, an event type encoding module 132, a relative location encoding module 133, a multilayer perceptron fusion module 134, and an element word information extraction module 135. The condition regularization module 131 is configured to fuse the trigger word vector output by the trigger word extraction layer 12 and each original word vector in the target text, to obtain each fused word vector. The event type encoding module 132 is configured to encode an event type corresponding to the trigger word, to obtain an event type vector. The relative location encoding module 133 is configured to generate a relative location vector through encoding based on a location of the trigger word in the target text. The multilayer perceptron fusion module 134 is configured to fuse each fused word vector, the event type vector, and the relative location vector to obtain a first element matrix. The element word information extraction module 135 is configured to extract element location information of each element word and an element relationship between the element words from the first element matrix, to generate an event extraction result corresponding to the target text based on the element location information of each element word and the element relationship between the element words.

The event extraction model is generated by performing training in advance based on a training sample set and a verification sample set. A training sample in the training sample set is input to the event extraction model, the event extraction model outputs a corresponding event extraction result, a loss function is constructed based on the corresponding event extraction result output by the event extraction model and verification data in the verification sample set, a model parameter is adjusted based on the loss function, to improve the event extraction effect of the event extraction model, and finally the event extraction model that satisfies a requirement is obtained after training.

Based on the model architecture diagram shown in FIG. 1, detailed descriptions are provided below with reference to specific implementations. The implementations described in the following example implementations do not indicate all implementations consistent with the present application. On the contrary, the implementations are merely examples of apparatuses and methods consistent with some aspects of the present application described in detail in the appended claims. The flowcharts shown in the accompanying drawings are merely examples for description, and do not need to be performed based on the illustrative steps. For example, some steps are parallel and do not have a strict logical order. Therefore, an actual execution order is variable.

FIG. 2 is a schematic flowchart illustrating an event extraction method according to some implementations of the present application. The event extraction method can specifically include the following steps.

S102: Identify at least one trigger word in a target text, and obtain a trigger word vector corresponding to each of the at least one trigger word. In some implementations, the target text on which event extraction is to be performed is input to the event extraction model shown in FIG. 1, a vector input layer in the event extraction model obtains a vector representation of each word in the target text, to generate an original word vector corresponding to each word in the target text, and a trigger word extraction layer identifies, based on each original word vector, whether there is a trigger word related to a determined (predetermined or dynamically determined) event type in the target text, and obtains a trigger word vector corresponding to each trigger word.

The trigger word is a word that is determined (predetermined or dynamically determined), that triggers an event, and that is representative in the event, and is usually a verb in the event. For example, “ [symbol] [symbol] 600 [symbol] ” in Chinese (and in English “Zhang San Capital significantly increases shareholding of Reese by 600 million shares”) includes an event of stock increase, and a trigger word is “ [symbol] ” in Chinese (and in English “increase”).

The event extraction model can be a pre-trained language representation model (e.g., Bidirectional Encoder Representation from Transformers, BERT).

In some implementations, an encoder part of the pre-trained language representation model (e.g., Bidirectional Encoder Representation from Transformers, BERT) is used as the vector input layer to obtain the vector representation of each word in the target text to obtain each original word vector corresponding to each word, and then the trigger word extraction layer performs binary classification processing on each original word vector by using a determined (predetermined or dynamically determined) binary classifier, to identify a trigger word vector corresponding to the at least one trigger word from all the original word vectors.

In some implementations, the target text including an overlapping event may include a plurality of trigger words. Therefore, all trigger words included in the target text can be obtained by separately identifying all the words in the target text by using the binary classifier. There can be a plurality of binary classifiers, each binary classifier corresponds to one event type, and each binary classifier can identify a trigger word of the corresponding event type.

In some implementations, the word can be each word obtained after word segmentation processing is performed on the target text. If the word is a word obtained after word segmentation processing is performed on the target text, binary classification processing can be directly performed on each original word vector based on a determined (predetermined or dynamically determined) binary classifier corresponding to the event type, and the trigger word vector corresponding to the at least one trigger word can be identified from all the original word vectors.

In some implementations, the word can also be a single word in the target text. If the word is a single word in the target text, the original word vector is a vector corresponding to the single word in the target text. In this case, in a process of performing binary classification processing on each original word vector based on the determined (predetermined or dynamically determined) binary classifier corresponding to the event type, the binary classifier should sequentially perform binary classification processing on all the original word vectors based on an initial order of the original word vectors in the target text. The binary classifier first determines a start word vector corresponding to a start word in the trigger word, and then the binary classifier sequentially performs binary classification processing on original word vectors after the start word vector starting from a location of the start word vector, to identify and determine an end word vector corresponding to an end word in the trigger word, and finally combines original word vectors included between the start word vector and the corresponding end word vector to generate the trigger word vector corresponding to the trigger word.

In some implementations, there may be a trigger word unrelated to the target text in the target text. Therefore, after the at least one trigger word is identified, screening processing can be performed on the at least one identified trigger word to exclude a trigger word that does not belong to the target text from the at least one identified trigger word. For example, the event extraction method provided in some implementations of the present application is implemented based on a deep learning-based event extraction model. Therefore, a trigger word constraint function can be set in a training phase of the event extraction model. The constraint function is used to restrict the trigger word extraction layer in the event extraction model, to prevent the trigger word extraction layer from extracting a trigger word that does not belong to the target text.

S104: Determine, in the target text, element word information associated with an event type corresponding to each trigger word based on the trigger word vector corresponding to each trigger word, an event type vector corresponding to each trigger word, and a relative location vector corresponding to each trigger word, where the element word information includes location information corresponding to each of at least one element word and an element relationship between the element words.

In some implementations, after the at least one trigger word in the target text is identified, and the trigger word vector corresponding to the trigger word is obtained, a target trigger word vector is selected from all the trigger word vectors, each of the at least one original word vector obtained by vectoring the target text is fused with the target trigger word vector, to obtain at least one fused word vector, the at least one fused word vector, an event type vector corresponding to a target trigger word, and a relative location vector corresponding to the target trigger word are fused through a multilayer perceptron, to generate a first element matrix, and element word information associated with an event type corresponding to the target trigger word is determined in the first element matrix.

The event type vector is used to indicate the event type corresponding to the trigger word, and the relative location vector is used to indicate a relative location relationship between a word and the trigger word in the target text.

The element word is a word associated with the corresponding event type in the target text, and a complete event includes both a trigger word and an element word. The element word is used to indicate an element that should be included in the event corresponding to the trigger word. For example, “ [symbol] [symbol] [symbol] [symbol] ” in Chinese (and in English “Oriental Holdings makes great efforts to acquire local leading enterprises Tiandi Source and East China Tiandi”) includes an acquisition event, and “ [symbol] ” in Chinese (and in English “Oriental Holdings”), “ [symbol] ” in Chinese (and in English “Tiandi Source”), and “ [symbol] ” in Chinese (and in English “East China Tiandi”) are all elements in the acquisition event.

In some implementations, there is a one-to-one correspondence between the binary classifier in the trigger word extraction layer and the event type, and the binary classifier can identify only the trigger word corresponding to the corresponding event type. After the trigger word is identified, the event type corresponding to the trigger word can be determined based on the binary classifier, then an element word required for extracting an event of the event type can be determined in the target text based on the event type, and finally an event extraction result can be generated based on location information corresponding to each element word and an element relationship between the element words. In some implementations, the event type corresponding to the target trigger word can be determined based on the one-to-one correspondence between the target binary classifier and the event type by determining a target binary classifier used to identify the target trigger word vector, and then an event type encoding module in an element information extraction layer encodes the event type corresponding to the target trigger word, to obtain the event type vector corresponding to the target trigger word.

Further, it is learned from S102 that when identifying the trigger word vector, the binary classifier first identifies the start word vector corresponding to the trigger word vector, and then identifies the end word vector corresponding to the trigger word vector. Therefore, location information of the target trigger word in the target text can be determined based on location information of a target start word vector and location information of a target end word vector corresponding to the target trigger word vector, and a relative location encoding module in the element information extraction layer generates the relative location vector of the target trigger word relative to each word in the target text through encoding based on the location information of the target trigger word in the target text.

Further, the fused word vector, the event type vector, and the relative location vector are fused through the multilayer perceptron, to generate the first element matrix. It should be appreciated that the fused word vector is each original word vector in which a trigger word feature is fused, and includes all text information in the target text. The event type vector includes an event type feature, the relative location vector includes a relative location relationship feature between each word and the target trigger word, and the fused word vector, the event type vector, and the relative location vector are fused based on the multilayer perceptron, to obtain the first element matrix including the features.

After the first element matrix is obtained, a location information vector including the element word location information of each element word associated with the event type and an element relationship vector including the element relationship between the element words are extracted from the first element matrix, biaffine transformation is performed on the location information vector and the element relationship vector to obtain a second element matrix, and the second element matrix is decoded in a determined (predetermined or dynamically determined) order to obtain the location information of each element word and the element relationship between the element words.

In some implementations, the target text including an overlapping event may include a plurality of trigger words. Therefore, when step S104 is performed, the trigger word needs to be used as a dimension, the trigger words are sequentially used as a target trigger word, and the following steps are performed on the target trigger word: fusing each of the at least one original word vector with a target trigger word vector, to obtain at least one fused word vector; determining an event type vector corresponding to the target trigger word vector based on the binary classifier; generating a relative location vector corresponding to the target trigger word vector based on location information of a target start word vector and location information of a target end word vector corresponding to the target trigger word vector; fusing the at least one fused word vector, the event type vector, and the relative location vector through a multilayer perceptron, to generate a first element matrix; and determining element word information associated with an event type corresponding to the target trigger word based on the first element matrix, to find the element word information associated with the event type corresponding to each trigger word.

S106: Generate an event extraction result corresponding to the target text based on the location information of each element word and the element relationship between the element words.

In some implementations, after the element word information associated with the event type corresponding to each trigger word is obtained, event extraction results corresponding to the corresponding trigger words are sequentially generated based on the location information of each element word and the element relationship between the element words corresponding to each trigger word, to obtain the event extraction results respectively corresponding to all the trigger words, and finally all event extraction results corresponding to the target text are obtained.

In some implementations, when there are a plurality of trigger words in the target text, the trigger word is used as a dimension, and event extraction results respectively corresponding to the trigger words are sequentially generated based on the location information of each element word and the element relationship between the element words corresponding to each trigger word, and finally all event extraction results corresponding to all the trigger words in the target text are obtained.

In some implementations, a directed acyclic graph including each element word is generated based on the location information of each element word and the element relationship between the element words, all element paths between any two element words are determined in the directed acyclic graph, at least one event path is determined among the element paths based on a longest non-implication rule, and the event extraction result corresponding to the target text is generated based on the event path.

In some implementations of the present application, the at least one trigger word in the target text is first identified; then by using the trigger word as a dimension, the event type vector corresponding to the trigger word is determined, the relative location vector corresponding to the trigger word is determined, and each of the at least one original word vector in the target text is fused with the trigger word vector, to obtain the at least one fused word vector; then the location information of each element word associated with the event type corresponding to the trigger word and the element relationship between the element words are found from the target text based on the event type vector, the relative location vector, and the at least one fused word vector; then the event extraction results respectively corresponding to all the trigger words are generated based on the location information of each element word and the element relationship between the element words; and finally all the event extraction results corresponding to all the trigger words in the target text are obtained. In this way, event extraction on the target text is implemented. In the method in which the trigger word is first determined and the corresponding element word information is determined based on the trigger word, a problem, in the existing technologies, that an event extraction result of extracting an overlapping event is unsatisfactory is effectively resolved, and an event extraction effect for the overlapping event is improved.

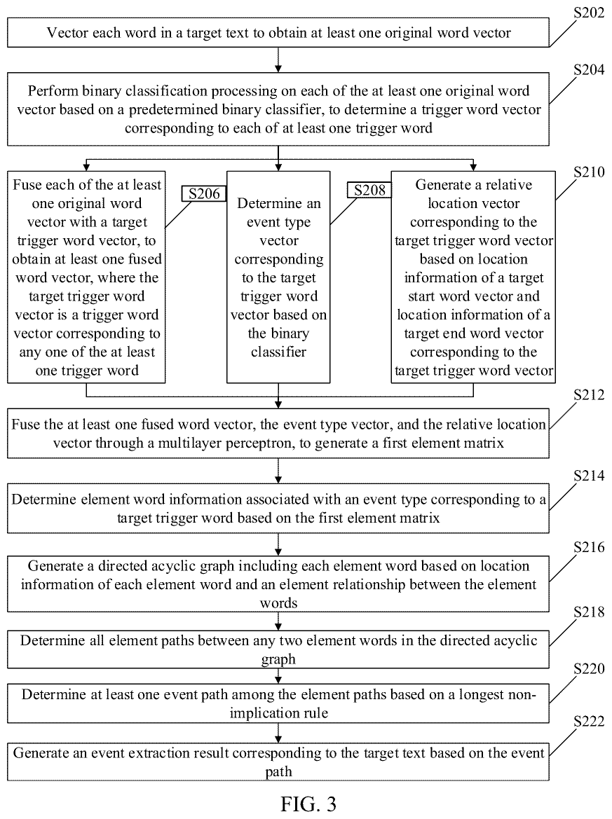

FIG. 3 is a schematic flowchart illustrating an event extraction method according to some implementations of the present application. The event extraction method can include the following steps.

S202: Vector each word in a target text to obtain at least one original word vector.

In some implementations, vector conversion processing is performed on each word in the target text based on a vector input layer in an event extraction model, to obtain an original word vector corresponding to each word.

The word is a single word in the target text. If the target text is Chinese, the word is a single word in the target text. If the target text is English, the word is a single English word in the target text.

For example, the target text is “ [symbol] [symbol] 600 [symbol] ” in Chinese (and in English “Zhang San Capital significantly increases shareholding of Reese by 600 million shares”). In this case, vector conversion processing is performed on each word in the target text based on the vector input layer in the event extraction model, to obtain an original word vector corresponding to each word in the target text, for example, an original word vector 1 corresponding to the word “ [symbol] ”, an original word vector 2 corresponding to the word “ [symbol] ”, an original word vector 3 corresponding to the word “ [symbol] ”, an original word vector 4 corresponding to the word “ [symbol] ”, an original word vector 5 corresponding to the word “ [symbol] ”, an original word vector 6 corresponding to the word “ [symbol] ”, an original word vector 7 corresponding to the word “ [symbol] ”, an original word vector 8 corresponding to the word “ [symbol] ”, an original word vector 9 corresponding to the word “ [symbol] ”, an original word vector 10 corresponding to the word “ [symbol] ”, an original word vector 11 corresponding to the word “ [symbol] ”, an original word vector 12 corresponding to the word “ [symbol] ”, an original word vector 13 corresponding to the word “600”, an original word vector 14 corresponding to the word “ [symbol] ”, and an original word vector 15 corresponding to the word “ [symbol] ”.

S204: Perform binary classification processing on each of the at least one original word vector based on a determined (predetermined or dynamically determined) binary classifier, to determine a trigger word vector corresponding to each of at least one trigger word.

The binary classifier is specified for constructing the event extraction model, and is determined (predetermined or dynamically determined) based on a category of an event type. Different binary classifiers can identify and determine only trigger words of corresponding event types. If the event extraction model extracts a plurality of event types, there are a plurality of binary classifiers.

In some implementations, binary classification processing is sequentially performed on all of the at least one original word vector based on an initial order of all the original word vectors in the target text by using the binary classifier, to determine at least one start word vector; based on the initial order of the original word vectors in the target text, a determined (predetermined or dynamically determined) number of original word vectors are sequentially identified starting from a location of each start word vector, to determine an end word vector corresponding to each start word vector; and original word vectors included between each start word vector and the corresponding end word vector are combined to generate a trigger word vector, to obtain the trigger word vector corresponding to each of the at least one trigger word.

The sequentially performing binary classification processing on all the original word vectors by using the binary classifier, to determine the at least one start word vector includes:

Tₛₜₐᵣₜ^{i=softmax(}MLP(h))

Herein, h is an original word vector set, and Tₛₜₐᵣₜⁱ is the probability that an i^{th} original word vector is a start word vector when being arranged based on the initial order of all the original word vectors in the target text.

The sequentially identifying, based on the initial order of the original word vectors in the target text, the determined (predetermined or dynamically determined) number of original word vectors starting from the location of each start word vector, to determine the end word vector corresponding to each start word vector includes:

T_{end}^{i=softmax(}MLP(h;Tₛₜₐᵣₜⁱ))

Herein, T_{end}ⁱ is the probability that the i^{th} original word vector is an end word vector.

In some implementations, when there is one binary classifier, the binary classifier performs binary classification processing on all the original word vectors based on the initial order of all the original word vectors in the target text, and searches all the original word vectors for a start word vector of a trigger word of an event type corresponding to the binary classifier. If the start word vector exists, the binary classifier continues to identify the determined (predetermined or dynamically determined) number of original word vectors starting from the start word vector, to determine an end word vector corresponding to the start word vector, and combines all original word vectors between the start word vector and the end word vector to generate a trigger word vector. If the start word vector does not exist, it is determined that there is no event that can be extracted by the event extraction model in the target text. The start word vector is an original word vector corresponding to the first word in the trigger word, and the end word vector is an original word vector corresponding to the last word in the trigger word. For example, if the target text is “ [symbol] [symbol] 600 [symbol] ” in Chinese (and in English “Zhang San Capital significantly increases shareholding of Reese by 600 million shares”), an event type existing in the target text is an event of stock increase, and a trigger word is “ [symbol] ” in Chinese (and in English “increase”). In this case, “ [symbol] ” is a start word in the trigger word, an original word vector corresponding to “ [symbol] ” is a start word vector of the trigger word, “ [symbol] ” is an end word in the trigger word, and an original word vector corresponding to “ [symbol] ” is an end word vector of the trigger word. The binary classifier sequentially performs binary classification processing on original word vectors of all words based on an order of “ [symbol] [symbol] [symbol] , [symbol] ”, and “ [symbol] ”, and identifies that the original word vector corresponding to “ [symbol] ” is the start word vector. Then, starting from “ [symbol] ”, the binary classifier continues to sequentially perform binary classification processing on the determined (predetermined or dynamically determined) number of original word vectors, identifies that the original word vector corresponding to “ [symbol] ” is the end word vector, and then fuses the original word vector corresponding to “ [symbol] ” and the original word vector corresponding to “ [symbol] ” to generate a trigger word vector corresponding to the trigger word “ [symbol] ” in Chinese (and in English “increase”).

In some implementations, considering that the trigger word is not excessively long, if the end word vector and the start word vector are separated excessively far away from each other, an incorrect identification result may be obtained. Therefore, after the start word vector corresponding to the trigger word is identified, to reduce an error, in a process of identifying the end word vector, the binary classifier adds a trigger word length constraint, and performs binary classification processing only on the determined (predetermined or dynamically determined) number of original word vectors after the start word vector, that is, identifies the end word vector only from the determined (predetermined or dynamically determined) number of original word vectors after the start word vector.

In some implementations, when there are a plurality of binary classifiers, an execution order can be set for the binary classifiers. A binary classifier with a higher execution ranking first performs binary classification processing on all the original word vectors based on the initial order of all the original word vectors in the target text. If the binary classifier finds a start word vector of a trigger word of an event type corresponding to the binary classifier, starting from the start word vector, the binary classifier continues to identify the determined (predetermined or dynamically determined) number of original word vectors, to determine an end word vector corresponding to the start word vector, and combines all original word vectors between the start word vector and the end word vector to generate a trigger word vector (namely, a vector representation of the trigger word of the event type corresponding to the binary classifier). If the binary classifier does not find a start word vector of a trigger word of an event type corresponding to the binary classifier, a binary classifier with a lower execution ranking continues to perform binary classification processing on all the original word vectors based on the initial order of all the original word vectors in the target text, and identifies a start word vector and an end word vector of a trigger word of a corresponding event type, to obtain a trigger word vector of the event type corresponding to the binary classifier. Finally, after all the binary classifiers complete identification, trigger word vectors respectively corresponding to all the trigger words in the target text can be obtained.

S206: Fuse each of the at least one original word vector with a target trigger word vector, to obtain at least one fused word vector, where the target trigger word vector is a trigger word vector corresponding to any one of the at least one trigger word.

In some implementations, a condition regularization module in an element information extraction layer in the event extraction model fuses the original word vector corresponding to each word in the target text with the target trigger word vector, to obtain a fused word vector corresponding to each word. The target trigger word vector is one of the trigger word vectors identified in step S204.

In some implementations, the target trigger word vector can be the first trigger word vector identified in step S204. As described above, when there are a plurality of trigger words in the target text, an execution order is set for all binary classifiers, and all the binary classifiers sequentially identify the trigger word vector in the target text based on the execution order. Therefore, the target trigger word vector can be the first trigger word vector identified by the binary classifier in the target text. After the binary classifier identifies the first trigger word vector in the target text, the trigger word vector is used as the target trigger word vector, and step S206 to step S222 are performed. After the binary classifier identifies the second trigger word vector in the target text, the second trigger word vector is used as the target trigger word vector, and step S206 to step S222 continue to be performed until events corresponding to all the trigger words in the target text are extracted.

S208: Determine an event type vector corresponding to the target trigger word vector based on the binary classifier.

In some implementations, the binary classifier is a determined (predetermined or dynamically determined) binary classifier that is in a one-to-one correspondence with the event type, an event type corresponding to a target trigger word is determined based on a target binary classifier corresponding to the target trigger word vector, the target binary classifier is a binary classifier used to identify the target trigger word vector, and an event type encoding module in the element information extraction layer in the event extraction model encodes the event type to obtain the event type vector corresponding to the target trigger word vector.

S210: Generate a relative location vector corresponding to the target trigger word vector based on location information of a target start word vector and location information of a target end word vector corresponding to the target trigger word vector.

In some implementations, the target start word vector and the target end word vector corresponding to the target trigger word vector are determined, location information of the target trigger word in the target text is determined based on the location information of the target start word vector and the location information of the target end word vector, and a relative location encoding module in the element information extraction layer in the event extraction model generates the relative location vector of the target trigger word relative to each word in the target text based on the location information of the target trigger word in the target text.

The relative location vector is used to indicate a relative location relationship between a word and the trigger word in the target text.

S212: Fuse the at least one fused word vector, the event type vector, and the relative location vector through a multilayer perceptron, to generate a first element matrix.

In some implementations, a multilayer perceptron fusion module in the element information extraction layer in the event extraction model fuses the at least one fused word vector, the event type vector, and the relative location vector corresponding to a target trigger word, to generate the first element matrix.

S214: Determine element word information associated with the event type corresponding to the target trigger word based on the first element matrix.

An element word is a word associated with a corresponding event type in the target text, and the element word information includes location information corresponding to each of at least one element word corresponding to the target trigger word and an element relationship between the element words.

In some implementations, an element word information extraction module in the element information extraction layer in the event extraction model extracts a location information vector of each element word associated with the event type corresponding to the target trigger word and an element relationship vector between the element words from the first element matrix, performs biaffine transformation on the location information vector and the element relationship vector to obtain a second element matrix, and decodes the second element matrix in a determined (predetermined or dynamically determined) order to obtain the location information of each element word and the element relationship between the element words.

In some implementations, the first element matrix is generated based on fusion of the at least one fused word vector, the event type vector, and the relative location vector, and includes a relative location relationship feature between the target trigger word and each word in the target text, an event type feature, and a target trigger word feature. The extracting the location information vector of each element word associated with the event type corresponding to the target trigger word from the first element matrix can be as follows:

A_{end}=softmax(MLP(a))

Where, A_{end} is a vector representation of an end word in a certain element word, and a is the first element matrix generated based on fusion of the at least one fused word vector, the event type vector, and the relative location vector. The vector representation of the end word in the element word is extracted from the first element matrix.

s=MLP([a;A_{end}])

Where, s is a location information vector corresponding to the element word. The location information vector corresponding to the element word is generated through encoding based on the vector representation of the end word in the element word.

The extracting the element relationship vector between the element words associated with the event type corresponding to the target trigger word from the first element matrix can include:

R=σ(a^{T}Wₐ)

r=MLP([a;R])

Where, r is the element relationship vector between the element words.

The performing biaffine transformation on the location information vector and the element relationship vector to obtain the second element matrix can be as follows:

yᵢⱼsᵢ^{T}Uᵣ_{ⱼ}+W[sᵢ;rⱼ]⇄b

Where, sᵢ is an i^{th} location information vector, rₕ is a h^{th} element relationship vector, and yᵢⱼ is a vector representation in a jₜₕ row and an i^{th} column in the second element matrix obtained by performing biaffine transformation on the location information vector and the element relationship vector.

The decoding the second element matrix in the determined (predetermined or dynamically determined) order, to obtain the location information of each element word and the element relationship between the element words can be as follows:

The second element matrix is decoded from top to bottom along a column to obtain the location information of each element word, and is decoded from left to right along a row to obtain an element relationship between the element words.

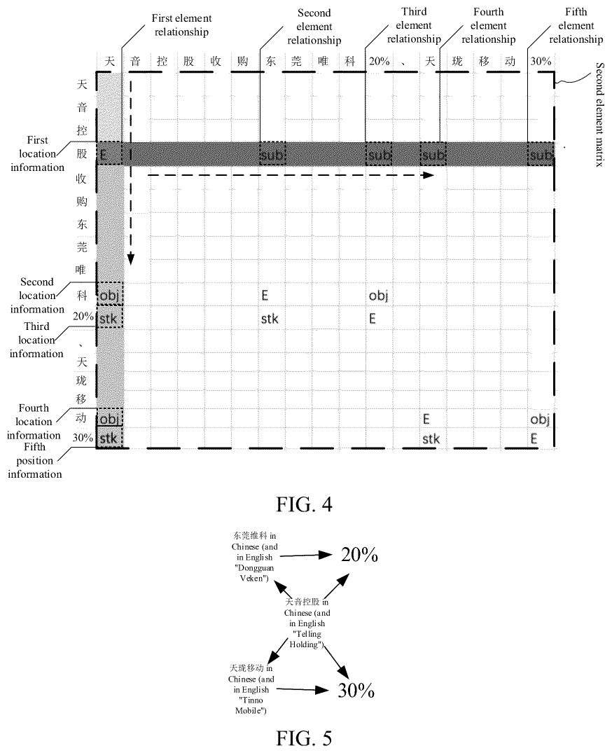

FIG. 4 is a schematic diagram illustrating an example of a second element matrix according to some implementations of the present application. FIG. 4 is a schematic diagram illustrating an example of a second element matrix generated in a process of performing event extraction on a certain target text. As shown in the figure, each grid in a dashed-line box is a vector yᵢⱼ and all vectors yᵢⱼ in the dashed-line box constitute the second element matrix. It is easily seen from the figure that when decoding is performed from top to bottom in a column direction, location information of an element word can be obtained each time a last word in the element word is decoded. As shown in the figure, first location information is location information of an element word “ [symbol] ” in Chinese (and in English “Telling Holding”), and second location information, third location information, fourth location information, and fifth location information respectively indicate location information of corresponding element words. When decoding is performed from left to right in a row direction, an element relationship between an element word in the row direction and an element word in the column direction can be obtained each time the first word in the element word is decoded. As shown in the figure, a first element relationship is an element relationship between the element word “ [symbol] ” in Chinese (and in English “Telling Holding”) and the element word “ [symbol] ” in Chinese (and in English “Telling Holding”), where E indicates that the element words are the same, a second element relationship is an element relationship between the element word “ [symbol] ” in Chinese (and in English “Telling Holding”) and an element word “ [symbol] ” in Chinese (and in English “Dongguan Veken”), where sub indicates that “ [symbol] ” in Chinese (and in English “Telling Holding”) is a subject of “ [symbol] ” in Chinese (and in English “Dongguan Veken”), and a third element relationship, a fourth element relationship, and a fifth element relationship respectively indicate element relationships between corresponding element words.

S216: Generate a directed acyclic graph including each element word based on the location information of each element word and the element relationship between the element words.

S218: Determine all element paths between any two element words in the directed acyclic graph.

In some implementations, in step S216 and step S218, after the location information of each element word and the element relationship between the element words are obtained, the directed acyclic graph including each element word is generated based on the location information of each element word and the element relationship between the element words, and all the element paths between the any two element words are determined in the directed acyclic graph.

FIG. 5 is a schematic diagram illustrating an example of a directed acyclic graph according to some implementations of the present application. FIG. 5 illustrates a directed acyclic graph generated after the locational information corresponding to each element word and the element relationship between the element words are extracted based on the second element matrix shown in FIG. 4. As shown in FIG. 5, the illustrative directed acyclic graph includes element words such as “ [symbol] ” in Chinese (and in English “Telling Holding”), “ [symbol] ” in Chinese (and in English “Dongguan Veken”), “ [symbol] ” in Chinese (and in English “Tinno Mobile”), “20%”, and “30%”, and based on the directed acyclic graph shown in the figure, it can be determined that element paths between two elements include “ [symbol] ” in Chinese (and in English “Telling Holding”)>“ [symbol] ” in Chinese (and in English “Dongguan Veken”), “ [symbol] ” in Chinese (and in English “Telling Holding”)>“ [symbol] ” aft in Chinese (and in English “Dongguan Veken”)>“20%”, “ [symbol] ” in Chinese (and in English “Dongguan Veken”)>“20%”, “ [symbol] ” in Chinese (and in English “Telling Holding”)>“20%”, “ [symbol] ” in Chinese (and in English “Telling Holding”)>“ [symbol] [symbol] ” in Chinese (and in English “Tinno Mobile”), “ [symbol] ” in Chinese (and in English “Telling Holding”)>“ [symbol] ” in Chinese (and in English “Tinno Mobile”)>“30%”, “ [symbol] ” in Chinese (and in English “Tinno Mobile”)>“30%”, and “ [symbol] ” in Chinese (and in English “Telling Holding”)>“30%”.

S220: Determine at least one event path among the element paths based on a longest non-implication rule.

In some implementations, among the element paths, a longest element path between two elements is found, and an element path included in another element path is discarded.

For example, in the element paths included in the directed acyclic graph shown in FIG. 5, a longest element path between “ [symbol] ” in Chinese (and in English “Telling Holding”) and “20%” is “ [symbol] ” in Chinese (and in English “Telling Holding”)>“ [symbol] ” in Chinese (and in English “Dongguan Veken”)>“20%”, and a longest element path between “ [symbol] ” in Chinese (and in English “Telling Holding”) and “ [symbol] ” in Chinese (and in English “Dongguan Veken”) is “ [symbol] ” in Chinese (and in English “Telling Holding”)>“ [symbol] ” aft in Chinese (and in English “Dongguan Veken”). The path “ [symbol] ” in Chinese (and in English “Telling Holding”)>“ [symbol] ” in Chinese (and in English “Dongguan Veken”)>“20%” includes the path “ [symbol] ” in Chinese (and in English “Telling Holding”)>“ [symbol] [symbol] ” in Chinese (and in English “Dongguan Veken”). Therefore, the path “ [symbol] ” in Chinese (and in English “Telling Holding”)>“ [symbol] ” aft in Chinese (and in English “Dongguan Veken”) is discarded, and only the path “ [symbol] ” in Chinese (and in English “Telling Holding”)>“ [symbol] ” in Chinese (and in English “Dongguan Veken”)>“20%” is retained.

S222: Generate an event extraction result corresponding to the target text based on the event path.

In some implementations, the event extraction result is generated based on the event path retained based on the longest non-implication rule in step S220. For example, the path “ [symbol] ” in Chinese (and in English “Telling Holding”)>“ [symbol] ” in Chinese (and in English “Dongguan Veken”)>“20%” is retained, and a trigger word corresponding to the path is “ [symbol] ” in Chinese (and in English “acquire”). Therefore, it can be obtained that the event extraction result is “ [symbol] [symbol] 20% [symbol] [symbol] ” in Chinese (and in English “Telling Holding acquires 20% of shares of Dongguan Veken”).

In some implementations of the present application, the at least one trigger word in the target text is first identified; then by using the trigger word as a dimension, the event type vector corresponding to the trigger word is determined, the relative location vector corresponding to the trigger word is determined, and each of the at least one original word vector in the target text is fused with the trigger word vector, to obtain the at least one fused word vector; then the event type vector, the relative location vector, and the at least one fused word vector are fused through the multilayer perceptron, to generate the first element matrix; then location information vectors and element relationship vectors of all the element words corresponding to the event type are sequentially extracted from the first element matrix, and biaffine transformation is performed on the location information vectors and the element relationship vectors of all the element words to obtain the second element matrix of a biaffine network; the location information of each element word associated with the event type corresponding to the trigger word and the element relationship between the element words in the target text are found in the second element matrix; then the directed acyclic graph is generated based on the location information of each element word and the element relationship between the element words; then an appropriate event path is found in the directed acyclic graph based on the longest non-implication rule; and finally the corresponding event extraction result is obtained based on the event path. In this way, event extraction on the target text is implemented. In the method in which the trigger word is first determined and the corresponding element word information is determined based on the trigger word, a problem, in the existing technologies, that an event extraction result of extracting an overlapping event is unsatisfactory is effectively resolved, and an event extraction effect for the overlapping event is improved. In addition, the second element matrix obtained based on biaffine transformation ensures an extraction effect for various overlapping events, and therefore stability of event extraction is greatly improved.

In some implementations of the present application, it should be appreciated that the event extraction model is a deep learning-based neural network model designed for events of several specific event types, and can extract the events corresponding to the several specific event types from a target text. If there is no event corresponding to the event type that can be extracted by the event extraction model in the target text, and the event extraction model cannot extract a corresponding event extraction result from the target text, prompt information “there is no event in the target text” is output.

In some implementations, when there is no event corresponding to the event type that can be extracted by the event extraction model in the target text, if the event extraction model does not identify at least one trigger word in the target text, prompt information “no trigger word can be identified in the target text, and there is no event in the target text” is output.

In some implementations, when there is no event corresponding to the event type that can be extracted by the event extraction model in the target text, if the event extraction model identifies at least one trigger word in the target text, and cannot extract corresponding element word information based on the trigger word, prompt information “no element word information can be identified in the target text, and there is no event in the target text” is output.

In some implementations, only when there is an event corresponding to the event type that can be extracted by the event extraction model in the target text, the event extraction model can extract the corresponding event extraction result from the target text by performing the method steps in the implementations shown in FIG. 2 and FIG. 3.

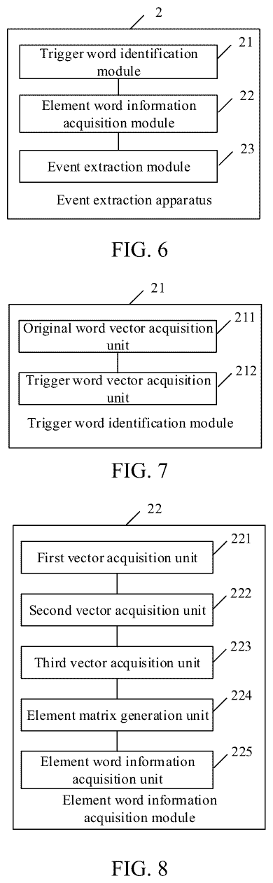

FIG. 6 is a schematic diagram illustrating a structure of an event extraction apparatus according to some implementations of the present application. As shown in FIG. 6, the event extraction apparatus 2 can be implemented as all or a part of a terminal by using software, hardware, or a combination of software and hardware. According to some implementations, the event extraction apparatus 2 includes a trigger word identification module 21, an element word information acquisition module 22, and an event extraction module 23. Details are as follows:

The trigger word identification module 21 is configured to: identify at least one trigger word in a target text, and obtain a trigger word vector corresponding to each of the at least one trigger word.

The element word information acquiring module 22 is configured to determine, in the target text, element word information associated with an event type corresponding to each trigger word based on the trigger word vector corresponding to each trigger word, an event type vector corresponding to each trigger word, and a relative location vector corresponding to each trigger word. The element word information includes location information corresponding to each of at least one element word and an element relationship between the element words.

The event extraction module 23 is configured to generate an event extraction result corresponding to the target text based on the location information of each element word and the element relationship between the element words.

The event type vector corresponding to each trigger word is used to indicate the event type corresponding to the trigger word, and the relative location vector corresponding to each trigger word is used to indicate a relative location relationship between a word and the trigger word in the target text.

In some implementations, FIG. 7 is a schematic diagram illustrating a structure of a trigger word identification module according to some implementations of the present application. As shown in FIG. 7, the trigger word identification module 21 includes: an original word vector acquisition unit 211, configured to vector each word in the target text to obtain at least one original word vector; and a trigger word vector acquisition unit 212, configured to perform binary classification processing on each of the at least one original word vector based on a determined (predetermined or dynamically determined) binary classifier, to determine a trigger word vector corresponding to each of the at least one trigger word.

In some implementations, the trigger word vector acquisition unit 212 is specifically configured to: sequentially perform binary classification processing on all of the at least one original word vector based on an initial order of all the original word vectors in the target text, to determine at least one start word vector; sequentially identify, based on the initial order of the original word vectors in the target text, a determined (predetermined or dynamically determined) number of original word vectors starting from a location of each start word vector, to determine an end word vector corresponding to each start word vector; and combine original word vectors included between each start word vector and the corresponding end word vector to generate a trigger word vector, to obtain the trigger word vector corresponding to each of the at least one trigger word.

In some implementations, the trigger word vector acquisition unit 212 is further configured to: perform binary classification processing on each of the at least one original word vector based on the at least one determined (predetermined or dynamically determined) binary classifier, to determine at least one initial trigger word vector; and select the trigger word vector corresponding to each of the at least one trigger word corresponding to the target text from the at least one initial trigger word vector.

In some implementations, FIG. 8 is a schematic diagram illustrating a structure of an element word information acquisition module according to some implementations of the present application. As shown in FIG. 8, the element word information acquisition module 22 includes: a first vector acquisition unit 221, configured to fuse each of the at least one original word vector with a target trigger word vector, to obtain at least one fused word vector, where the target trigger word vector is a trigger word vector corresponding to any one of the at least one trigger word; a second vector acquisition unit 222, configured to determine an event type vector corresponding to the target trigger word vector based on the binary classifier; a third vector acquisition unit 223, configured to generate a relative location vector corresponding to the target trigger word vector based on location information of a target start word vector and location information of a target end word vector corresponding to the target trigger word vector; an element matrix generation unit 224, configured to fuse the at least one fused word vector, the event type vector, and the relative location vector through a multilayer perceptron, to generate a first element matrix; and an element word information acquisition unit 225, configured to determine element word information associated with an event type corresponding to a target trigger word based on the first element matrix.

In some implementations, the second vector acquisition unit 222 is specifically configured to: determine the event type corresponding to the target trigger word based on a target binary classifier corresponding to the target trigger word vector, where the target binary classifier is a binary classifier used to identify the target trigger word vector; and encode the event type to obtain the event type vector corresponding to the target trigger word vector.

In some implementations, the third vector acquisition unit 223 is specifically configured to: determine the target start word vector and the target end word vector corresponding to the target trigger word vector; determine location information of the target trigger word in the target text based on the location information of the target start word vector and the location information of the target end word vector; and generate the relative location vector of the target trigger word relative to each word in the target text based on the location information of the target trigger word in the target text.

In some implementations, the element word information acquisition unit 225 is specifically configured to: extract a location information vector of at least one element word corresponding to the event type corresponding to the target trigger word and an element relationship vector between the element words from the first element matrix; perform biaffine transformation on the location information vector and the element relationship vector to obtain a second element matrix; and decode the second element matrix in a determined (predetermined or dynamically determined) order, to obtain location information of each element word and an element relationship between the element words.

In some implementations, the event extraction module 23 is specifically configured to: generate a directed acyclic graph including each element word based on the location information of each element word and the element relationship between the element words; determine all element paths between any two element words in the directed acyclic graph; determine at least one event path among the element paths based on a longest non-implication rule; and generate the event extraction result corresponding to the target text based on the event path.

According to the event extraction apparatus provided in some implementations of the present application, the at least one trigger word in the target text is first identified; then by using the trigger word as a dimension, the event type vector corresponding to the trigger word is determined, the relative location vector corresponding to the trigger word is determined, and each of the at least one original word vector in the target text is fused with the trigger word vector, to obtain the at least one fused word vector; then the event type vector, the relative location vector, and the at least one fused word vector are fused through the multilayer perceptron, to generate the first element matrix; then location information vectors and element relationship vectors of all the element words corresponding to the event type are sequentially extracted from the first element matrix, and biaffine transformation is performed on the location information vectors and the element relationship vectors of all the element words to obtain the second element matrix of a biaffine network; the location information of each element word associated with the event type corresponding to the trigger word and the element relationship between the element words in the target text are found in the second element matrix; then the directed acyclic graph is generated based on the location information of each element word and the element relationship between the element words; then an appropriate event path is found in the directed acyclic graph based on the longest non-implication rule; and finally the corresponding event extraction result is obtained based on the event path. In this way, event extraction on the target text is implemented. In the method in which the trigger word is first determined and the corresponding element word information is determined based on the trigger word, a problem, in the existing technologies, that an event extraction result of extracting an overlapping event is unsatisfactory is effectively resolved, and an event extraction effect for the overlapping event is improved. In addition, the second element matrix obtained based on biaffine transformation ensures an extraction effect for various overlapping events, and therefore stability of event extraction is greatly improved.

Some implementations of the present application further provides a computer storage medium. The computer storage medium can store a plurality of instructions, and the instructions are adapted to be loaded by a processor and to perform the event extraction method in the implementations shown in FIG. 1 to FIG. 5. For a specific execution process, references can be made to the detailed descriptions in the implementations shown in FIG. 1 to FIG. 5. Details are omitted herein for simplicity.

The present application further provides a computer program product. The computer program product stores at least one instruction, and the at least one instruction is to be loaded by a processor and to be used to perform the event extraction method in the implementations shown in FIG. 1 to FIG. 5. For a specific execution process, references can be made to the detailed descriptions in the implementations shown in FIG. 1 to FIG. 5. Details are omitted herein for simplicity.

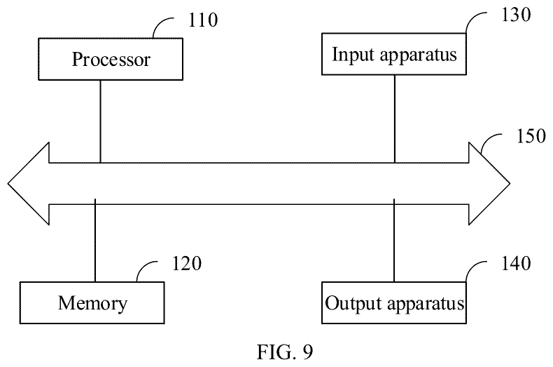

FIG. 9 is a block diagram illustrating a structure of an electronic device according to an example implementation of the present application. The electronic device in the present application can include one or more of the following components: a processor 110, a memory 120, an input apparatus 130, an output apparatus 140, and a bus 150. The processor 110, the memory 120, the input apparatus 130, and the output apparatus 140 can be connected by using the bus 150.

The processor 110 can include one or more processing cores. The processor 110 connects various parts within the entire electronic device by using various interfaces and lines, and performs various functions of the electronic device 100 and processes data by running or executing instructions, a program, a code set, or an instruction set stored in the memory 120 and by invoking data stored in the memory 120. In some implementations, the processor 110 can be implemented in at least one hardware form in a digital signal processor (digital signal processing unit, DSP), a field-programmable gate array (field-programmable gate array, FPGA), or a programmable logic array (programmable logic array, PLA). One or a combination of a central processing unit (central processing unit, CPU), a graphics processing unit (graphics processing unit, GPU), a modem, and the like can be integrated into the processor 110. The CPU mainly processes an operating system, a user interface, an application program, and the like. The GPU is responsible for rendering and drawing of display content. The modem is configured to process wireless communication. It should be appreciated that the modem may not be integrated into the processor 110, and is implemented by using a single communication chip.

The memory 120 can include a random access memory (random Access Memory, RAM), or can include a read-only memory (read-only memory, ROM). In some implementations, the memory 120 includes a non-transitory computer-readable medium (non-transitory computer-readable storage medium). The memory 120 can be configured to store instructions, a program, code, a code set, or an instruction set.

The input apparatus 130 is configured to receive input instructions or data, and the input apparatus 130 includes but is not limited to a keyboard, a mouse, a camera, a microphone, or a touch device. The output apparatus 140 is configured to output instructions or data, and the output apparatus 140 includes but is not limited to a display device, a speaker, and the like. In some implementations of the present application, the input apparatus 130 can be a temperature sensor, configured to obtain a running temperature of the electronic device. The output apparatus 140 can be a speaker, configured to output an audio signal.

In addition, it should be appreciated by a person skilled in the art that the structure of the electronic device shown in the figure does not constitute a limitation on the electronic device. The electronic device can include more or fewer components than those shown in the figure, some components can be combined, or different component arrangements can be used. For example, the electronic device further includes a radio frequency circuit, an input unit, a sensor, an audio circuit, a wireless fidelity (wireless fidelity, WiFi) module, a power supply, and a Bluetooth module. Details are omitted herein for simplicity.

In some implementations of the present application, each step can be performed by the electronic device described above. In some implementations, each step is performed by an operating system of the electronic device. The operating system can be an Android system, an iOS system, or another operating system. This is not limited in some implementations of the present application.

In the electronic device in FIG. 9, the processor 110 can be configured to: invoke an event extraction program stored in the memory 120, and execute the program, to implement the event extraction method described in the method implementations of the present application.

In the implementations of the present application, the at least one trigger word in the target text is first identified; then by using the trigger word as a dimension, the event type vector corresponding to the trigger word is determined, the relative location vector corresponding to the trigger word is determined, and each of the at least one original word vector in the target text is fused with the trigger word vector, to obtain the at least one fused word vector; then the event type vector, the relative location vector, and the at least one fused word vector are fused through the multilayer perceptron, to generate the first element matrix; then location information vectors and element relationship vectors of all the element words corresponding to the event type are sequentially extracted from the first element matrix, and biaffine transformation is performed on the location information vectors and the element relationship vectors of all the element words to obtain the second element matrix of a biaffine network; the location information of each element word associated with the event type corresponding to the trigger word and the element relationship between the element words in the target text are found in the second element matrix; then the directed acyclic graph is generated based on the location information of each element word and the element relationship between the element words; then an appropriate event path is found in the directed acyclic graph based on the longest non-implication rule; and finally the corresponding event extraction result is obtained based on the event path. In this way, event extraction on the target text is implemented. In the method in which the trigger word is first determined and the corresponding element word information is determined based on the trigger word, a problem, in the existing technologies, that an event extraction result of extracting an overlapping event is unsatisfactory is effectively resolved, and an event extraction effect for the overlapping event is improved. In addition, the second element matrix obtained based on biaffine transformation ensures an extraction effect for various overlapping events, and therefore stability of event extraction is greatly improved.

A person skilled in the art can clearly understand that the technical solutions of the present application can be implemented by using software and/or hardware. The “unit” and “module” in the present application refer to software and/or hardware that can independently complete or cooperate with other components to complete specific functions. The hardware can be, for example, a field-programmable gate array (Field-Programmable Gate Array, FPGA) or an integrated circuit (Integrated Circuit, IC).

It should be noted that for brief description, the above method implementations are represented as a series of actions. However, it should be appreciated by a person skilled in the art that the present application is not limited to the described order of the actions, because according to the present application, some steps can be performed in other orders or simultaneously. It should be further appreciated by a person skilled in the art that all of the implementations described in the present specification are preferred implementations, and the involved actions and modules are not necessarily required by the present application.

In the above implementations, each implementation is described by focusing on a different aspect. For a part that is not described in detail in some implementations, refer to the related descriptions in another implementation.

In the several implementations provided in the present application, it should be appreciated that the disclosed apparatus can be implemented in other manners. For example, the described apparatus implementation is merely an example. For example, division into the units is merely logical function division and may be other division in actual implementation. For example, a plurality of units or components can be combined or integrated into another system, or some features can be ignored or not performed. In addition, the displayed or discussed mutual couplings or direct couplings or communication connections can be implemented through some service interfaces. The indirect couplings or communication connections between the apparatuses or units can be implemented in electronic or other forms.

The units described as separate parts may or may not be physically separate, and parts displayed as units may or may not be physical units, can be located in one position, or can be distributed on a plurality of network units. Some or all of the units can be selected based on actual requirements to achieve the objectives of the solutions of the implementations.

In addition, functional units in the implementations of the present application can be integrated into one processing unit, each of the units can exist alone physically, or two or more units can be integrated into one unit. The integrated unit can be implemented in a form of hardware, or can be implemented in a form of a software functional unit.

It should be appreciated by a person of ordinary skill in the art that all or some of the steps of the various methods in the above implementations can be performed by a program by instructing related hardware. The program can be stored in a computer-readable memory. The memory can include a flash drive, a read-only memory (Read-Only Memory, ROM), a random access memory (Random Access Memory, RAM), a magnetic disk, an optical disk, or the like.

The above descriptions are merely example implementations of the present application, and are not intended to limit the scope of the present application. That is, all equivalent variations and modifications made in accordance with the teachings of the present application fall within the scope of the present application. A person skilled in the art can easily think of another implementation solution of the present application after considering the specification and practicing the disclosure herein. The present application is intended to cover any variations, uses, or adaptations of the present application. Example embodiments or implementations of the specification can be combined or modified in various ways to generate further embodiments, which are included in the scope of the disclosure. These variations, uses, or adaptations follow the general principles of the present application and include common knowledge or conventional technical means in the art that are not recorded in the present application. The specification and the implementations are merely considered as examples, and the scope and spirit of the present application are subject to the claims.

What is claimed is:

1. A method, comprising:
identifying at least one trigger word in a target text;
obtaining a trigger word vector corresponding to each of the at least one trigger word;
determining, in the target text, element word information associated with an event type corresponding to each trigger word based on the trigger word vector corresponding to each trigger word, an event type vector corresponding to each trigger word, and a relative location vector corresponding to each trigger word, wherein the element word information includes location information corresponding to each of at least one element word and an element relationship between the element words; and
generating an event extraction result corresponding to the target text based on the location information of each element word and the element relationship between the element words,
wherein the event type vector corresponding to each trigger word indicates the event type corresponding to the trigger word, and the relative location vector corresponding to each trigger word indicates a relative location relationship between a word and the trigger word in the target text.

2. The method according to claim 1, wherein the obtaining the trigger word vector corresponding to each of the at least one trigger word includes:
vectoring each word in the target text to obtain at least one original word vector; and
performing binary classification processing on each of the at least one original word vector based on a determined binary classifier, to determine the trigger word vector corresponding to each of the at least one trigger word.

3. The method according to claim 2, wherein the performing binary classification processing on each of the at least one original word vector based on the at least one determined binary classifier, to determine the trigger word vector corresponding to each of the at least one trigger word includes:
sequentially performing binary classification processing on all of the at least one original word vector based on an initial order of all the original word vectors in the target text, to determine at least one start word vector;
sequentially identifying, based on the initial order of the original word vectors in the target text, a determined number of original word vectors starting from a location of each start word vector, to determine an end word vector corresponding to each start word vector; and
combining original word vectors included between each start word vector and the corresponding end word vector to generate a trigger word vector, thereby obtaining the trigger word vector corresponding to each of the at least one trigger word.

4. The method according to claim 2, wherein the performing binary classification processing on each of the at least one original word vector based on the at least one determined binary classifier, to determine the trigger word vector corresponding to each of the at least one trigger word includes:
performing binary classification processing on each of the at least one original word vector based on the at least one determined binary classifier, to determine at least one initial trigger word vector; and
selecting the trigger word vector corresponding to each of the at least one trigger word corresponding to the target text from the at least one initial trigger word vector.

5. The method according to claim 2, wherein the determining, in the target text, the element word information associated with the event type corresponding to each trigger word based on the trigger word vector corresponding to each trigger word includes:
fusing each of the at least one original word vector with a target trigger word vector to obtain at least one fused word vector, wherein the target trigger word vector is a trigger word vector corresponding to any one of the at least one trigger word;
determining an event type vector corresponding to the target trigger word vector based on the binary classifier;
generating a relative location vector corresponding to the target trigger word vector based on location information of a target start word vector and location information of a target end word vector corresponding to the target trigger word vector;
fusing the at least one fused word vector, the event type vector, and the relative location vector through a multilayer perceptron to generate a first element matrix; and
determining element word information associated with an event type corresponding to a target trigger word based on the first element matrix.

6. The method according to claim 5, wherein the determining the event type vector corresponding to the target trigger word vector based on the binary classifier includes:
determining the event type corresponding to the target trigger word based on a target binary classifier corresponding to the target trigger word vector, wherein the target binary classifier is a binary classifier that identifies the target trigger word vector; and
encoding the event type to obtain the event type vector corresponding to the target trigger word vector.

7. The method according to claim 5, wherein the generating the relative location vector corresponding to the target trigger word vector based on the location information of the start word vector and the location information of the end word vector corresponding to the target trigger word vector includes:
determining the target start word vector and the target end word vector corresponding to the target trigger word vector;
determining location information of the target trigger word in the target text based on the location information of the target start word vector and the location information of the target end word vector; and
generating the relative location vector of the target trigger word relative to each word in the target text based on the location information of the target trigger word in the target text.

8. The method according to claim 5, wherein the determining the element word information associated with the event type corresponding to the target trigger word based on the first element matrix includes:
extracting a location information vector of each element word associated with the event type corresponding to the target trigger word and an element relationship vector between the element words from the first element matrix;
performing biaffine transformation on the location information vector and the element relationship vector to obtain a second element matrix; and
decoding the second element matrix in a determined order, to obtain location information of each element word and an element relationship between the element words.

9. The method according to claim 1, wherein the generating the event extraction result corresponding to the target text based on the location information of each element word and the element relationship between the element words includes:
generating a directed acyclic graph including each element word based on the location information of each element word and the element relationship between the element words;
determining all element paths between any two element words in the directed acyclic graph;
determining at least one event path among the element paths based on a longest non-implication rule; and
generating the event extraction result corresponding to the target text based on the event path.

10. A computing system comprising one or more processors and one or more memory devices, the one or more memory devices having computer executable instructions stored thereon, which when executed by the one or more processors, enable the one or processors to implement acts including:
identifying at least one trigger word in a target text;
obtaining a trigger word vector corresponding to each of the at least one trigger word;
determining, in the target text, element word information associated with an event type corresponding to each trigger word based on the trigger word vector corresponding to each trigger word, an event type vector corresponding to each trigger word, and a relative location vector corresponding to each trigger word, wherein the element word information includes location information corresponding to each of at least one element word and an element relationship between the element words; and
generating an event extraction result corresponding to the target text based on the location information of each element word and the element relationship between the element words,
wherein the event type vector corresponding to each trigger word indicates the event type corresponding to the trigger word, and the relative location vector corresponding to each trigger word indicates a relative location relationship between a word and the trigger word in the target text.

11. The computing system according to claim 10, wherein the obtaining the trigger word vector corresponding to each of the at least one trigger word includes:
vectoring each word in the target text to obtain at least one original word vector; and
performing binary classification processing on each of the at least one original word vector based on a determined binary classifier, to determine the trigger word vector corresponding to each of the at least one trigger word.

12. The computing system according to claim 11, wherein the performing binary classification processing on each of the at least one original word vector based on the at least one determined binary classifier, to determine the trigger word vector corresponding to each of the at least one trigger word includes:
sequentially performing binary classification processing on all of the at least one original word vector based on an initial order of all the original word vectors in the target text, to determine at least one start word vector;
sequentially identifying, based on the initial order of the original word vectors in the target text, a determined number of original word vectors starting from a location of each start word vector, to determine an end word vector corresponding to each start word vector; and
combining original word vectors included between each start word vector and the corresponding end word vector to generate a trigger word vector, thereby obtaining the trigger word vector corresponding to each of the at least one trigger word.

13. The computing system according to claim 11, wherein the performing binary classification processing on each of the at least one original word vector based on the at least one determined binary classifier, to determine the trigger word vector corresponding to each of the at least one trigger word includes:
performing binary classification processing on each of the at least one original word vector based on the at least one determined binary classifier, to determine at least one initial trigger word vector; and
selecting the trigger word vector corresponding to each of the at least one trigger word corresponding to the target text from the at least one initial trigger word vector.

14. The computing system according to claim 11, wherein the determining, in the target text, the element word information associated with the event type corresponding to each trigger word based on the trigger word vector corresponding to each trigger word includes:
fusing each of the at least one original word vector with a target trigger word vector to obtain at least one fused word vector, wherein the target trigger word vector is a trigger word vector corresponding to any one of the at least one trigger word;
determining an event type vector corresponding to the target trigger word vector based on the binary classifier;
generating a relative location vector corresponding to the target trigger word vector based on location information of a target start word vector and location information of a target end word vector corresponding to the target trigger word vector;
fusing the at least one fused word vector, the event type vector, and the relative location vector through a multilayer perceptron to generate a first element matrix; and
determining element word information associated with an event type corresponding to a target trigger word based on the first element matrix.

15. The computing system according to claim 14, wherein the determining the event type vector corresponding to the target trigger word vector based on the binary classifier includes:
determining the event type corresponding to the target trigger word based on a target binary classifier corresponding to the target trigger word vector, wherein the target binary classifier is a binary classifier that identifies the target trigger word vector; and
encoding the event type to obtain the event type vector corresponding to the target trigger word vector.

16. The computing system according to claim 14, wherein the generating the relative location vector corresponding to the target trigger word vector based on the location information of the start word vector and the location information of the end word vector corresponding to the target trigger word vector includes:
determining the target start word vector and the target end word vector corresponding to the target trigger word vector;
determining location information of the target trigger word in the target text based on the location information of the target start word vector and the location information of the target end word vector; and
generating the relative location vector of the target trigger word relative to each word in the target text based on the location information of the target trigger word in the target text.

17. The computing system according to claim 14, wherein the determining the element word information associated with the event type corresponding to the target trigger word based on the first element matrix includes:
extracting a location information vector of each element word associated with the event type corresponding to the target trigger word and an element relationship vector between the element words from the first element matrix;
performing biaffine transformation on the location information vector and the element relationship vector to obtain a second element matrix; and
decoding the second element matrix in a determined order, to obtain location information of each element word and an element relationship between the element words.

18. The computing system according to claim 10, wherein the generating the event extraction result corresponding to the target text based on the location information of each element word and the element relationship between the element words includes:
generating a directed acyclic graph including each element word based on the location information of each element word and the element relationship between the element words;
determining all element paths between any two element words in the directed acyclic graph;
determining at least one event path among the element paths based on a longest non-implication rule; and
generating the event extraction result corresponding to the target text based on the event path.

19. A non-transitory storage medium having computer executable instructions stored thereon, the computer executable instructions, when executed by the one or more processors, configuring the one or processors to implement actions including:
identifying at least one trigger word in a target text;
obtaining a trigger word vector corresponding to each of the at least one trigger word;
determining, in the target text, element word information associated with an event type corresponding to each trigger word based on the trigger word vector corresponding to each trigger word, an event type vector corresponding to each trigger word, and a relative location vector corresponding to each trigger word, wherein the element word information includes location information corresponding to each of at least one element word and an element relationship between the element words; and
generating an event extraction result corresponding to the target text based on the location information of each element word and the element relationship between the element words,
wherein the event type vector corresponding to each trigger word indicates the event type corresponding to the trigger word, and the relative location vector corresponding to each trigger word indicates a relative location relationship between a word and the trigger word in the target text.

20. The non-transitory storage medium according to claim 19, wherein the obtaining the trigger word vector corresponding to each of the at least one trigger word includes:
vectoring each word in the target text to obtain at least one original word vector; and
performing binary classification processing on each of the at least one original word vector based on a determined binary classifier, to determine the trigger word vector corresponding to each of the at least one trigger word.
